(19) United States
(12) Patent Application Publication
(10) Pub. No.: US 2012/0242333 A1
(43) Pub. Date: Sep. 27, 2012

(54) MAGNETIC STEERING APPLICATION FOR SINGULATED (X) MR SENSORS

(75) Inventors: Jochen Eshold, Ruschwedel (DE); Giovanni Basile, Hamburg (DE); Tom Holtz, Hamburg (DE); Oliver Heidrich, Hamburg (DE)

(73) Assignee: NXP B.V., Eindhoven (NL)

(21) Appl. No.: 13/513,673

(22) PCT Filed: Dec. 8, 2009
(86) PCT No.: PCT/IB2009/055567

§ 371 Date: Jun. 4, 2012

(51) Int. Cl. G01N 27/72

(52) U.S. Cl. 324/228

(57) ABSTRACT

A controller for a test head module (106) of a test cell (100) includes a control signal generator, an electronic memory device, and a signal evaluation module. The control signal generator to provide control signals to a plurality of magnetic stimulator heads, which provide magnetic stimulus signals to singulated devices for testing in response to the control signals. The electronic memory device stores instructions for controlling concurrent activation of at least two of the magnetic stimulator heads for parallel testing of the singulated devices. The signal evaluation module receives electrical signals from the singulated devices. The electrical signals from the singulated devices are dependent on the magnetic stimulus signals applied to the singulated devices.

Many types of integrated circuit (IC) chips are used in safety devices and applications. For example, IC chips (devices) are used in conjunction with anti-lock braking systems and steering systems in automobiles to improve the performance of these systems. Testing of the IC devices using such safety devices is important to insure that the safety devices will operate properly within the environment in which the safety devices are designed to operate.

In order to maintain a high quality of testing, IC dies are pre-tested on the wafer level. Subsequently, the wafer ICs are singulated, or separated and placed in individual IC packages, prior to final testing. In fact, some industry standards require testing of singulated devices to avoid using IC dies that might test successfully prior to singulation but are damaged electrically or mechanically during the singulation process.

One type of testing system that is capable of testing non-singulated IC packages is the InStrip® test handler available from Multitest of Rosenheim, Germany. The InStrip® test handler is alternatively referred to as an InCarrier test handler for singulated packages loaded onto a carrier. In general, this InCarrier handler combined with a test system (Test cell) performs customized stimuli (e.g., electro-magnetic stimuli) testing on the device to ensure that the circuitry of the device functions properly. More specifically, this handler accommodates testing of multiple devices on a carrier by indexing several stimuli in parallel to a number of devices and reading the output signals as a result of the device behavior. The test cell generates magnetic stimulation using a rotating magnet to stimulate the devices to the expected output of the sensor.

Existing sensor test cells provide a modular testing platform that can test dedicated types of sensor packages only by using customized package handling. The testing throughput of these test cells is relatively slow. Thus, these test cells perform testing of singulated devices on actual full customized equipment with a low multisite (i.e., testing of several devices in parallel at the same time) amount. Conventional customized test cells do not allow an increase in throughput and capacity with higher multisite count.

Embodiments of a new test cell are described herein to provide a flexible solution regarding the number of devices that can be tested in parallel, as well as a flexible solution for testing different kind of packages and devices without modifications, or with only minor modifications. By way of comparison, the conventional methods described above do not provide such flexible solutions.

Embodiments described herein generally relate to a magnetic stimuli application for magneto-resistive (MR) sensors. There are different types of devices such as MR sensors which interact with a magnetic field, including anisotropic (A)MR, giant (G)MR, and terra (T)MR sensors. For convenience, these different types of MR sensors are generically referred to as (X)MR sensors, where the “X” represents one or more of the “A,” “G,” and “T” designations. In a specific embodiment, the magnetic stimuli application is in an improved or optimized arrangement to realize a high throughput multisite approach.

At least one embodiment described herein combines features from both the InCarrier standard industrial test handler and a dynamic shielded magnetic stimulus. This combination results in a sensor final test solution with the possibility of a multisite approach, which means that several dynamic shielded MR stimuli may be driven in parallel to stimulate and test several devices in parallel. A potential advantage of one embodiment is high parallelism of testing (X)MR sensor devices, resulting in high throughput and cost reduction compared to conventional final test solutions. By way of comparison, conventional testing equipment hampers parallel sensor testing due to limitations of magnetic stimuli, contacting, and tempering of singulated devices.

Embodiments of a system are described. In one embodiment, the system includes a carrier handler module and a test head module. The carrier handler module has a chuck to position a device carrier for testing a plurality of singulated devices mounted within the device carrier. The test head module facilitates the testing of the singulated devices under application environmental conditions. In one embodiment, the test head module includes a plurality of magnetic stimulator heads and a controller. The magnetic stimulator heads provide magnetic stimulus signals to the singulated devices. The controller controls concurrent activation of at least two of the magnetic stimulator heads for parallel testing of the singulated devices. Other embodiments of the system are also described.

Embodiments of an apparatus are also described. In one embodiment, the apparatus is a controller for a test head module of a test cell. An embodiment of the controller includes a control signal generator, an electronic memory device, and a signal evaluation module. The control signal generator provides control signals to a plurality of magnetic stimulator heads, which provide magnetic stimulus signals to singulated devices for testing in response to the control signals. The electronic memory device stores instructions for controlling concurrent activation of at least two of the magnetic stimulator heads for parallel testing of the singulated devices. The signal evaluation module receives electrical signals from the singulated devices. The electrical signals from the singulated devices are dependent on the magnetic stimulus signals applied to the singulated devices. Other embodiments of the apparatus are also described.

Embodiments of a method are also described. In one embodiment, the method is a method for controlling a test head module of a test cell. An embodiment of the method includes providing control signals to a plurality of magnetic stimulator heads. Each magnetic stimulator head provides magnetic stimulus signals to singulated devices for testing in response to the control signals. The method also includes controlling concurrent activation of at least two of the magnetic stimulator heads for parallel testing of the singulated devices. The method also includes receiving electrical signals from the singulated devices. The electrical signals from the singulated devices are dependent on the magnetic stimulus signals applied to the singulated devices. Other embodiments of the method are also described.

Other aspects and advantages of embodiments of the present invention will become apparent from the following detailed description, taken in conjunction with the accompanying drawings, illustrated by way of example of the principles of the invention.

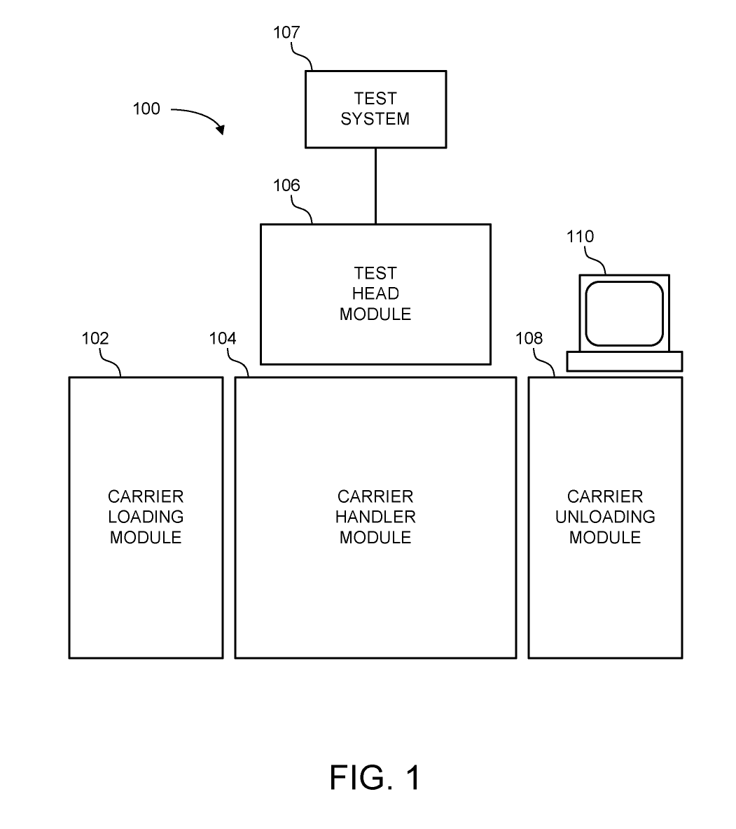

FIG. 1 depicts a schematic block diagram of one embodiment of a test cell.

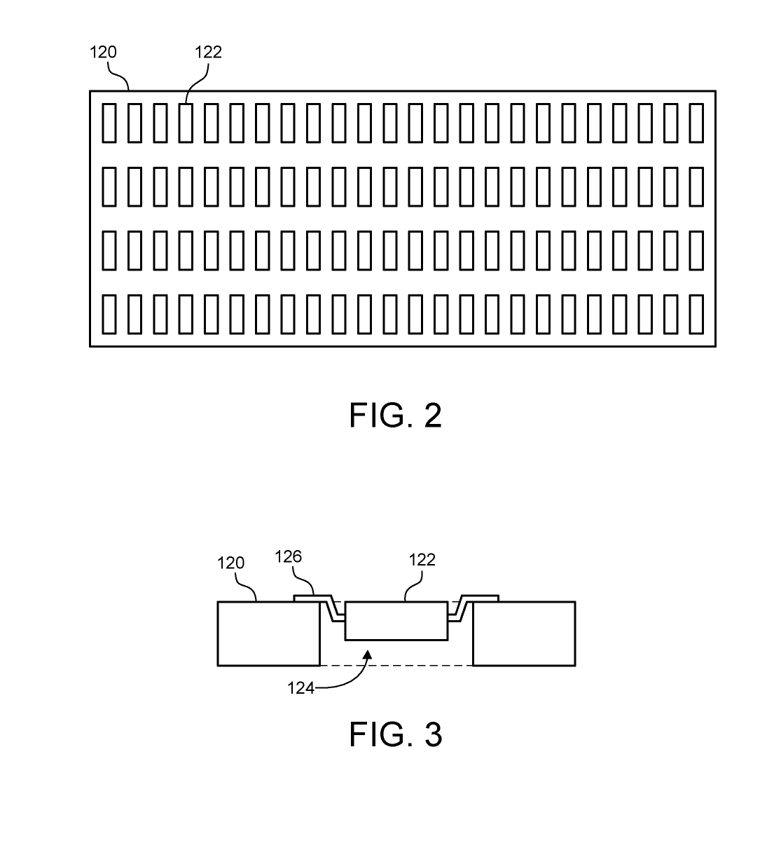

FIG. 2 depicts a schematic diagram of one embodiment of a carrier to hold a plurality of singulated sensor devices for testing in the test cell of FIG. 1.

FIG. 3 depicts a sectional view of one embodiment of a singulated sensor device positioned in a mounting aperture of the carrier of FIG. 2.

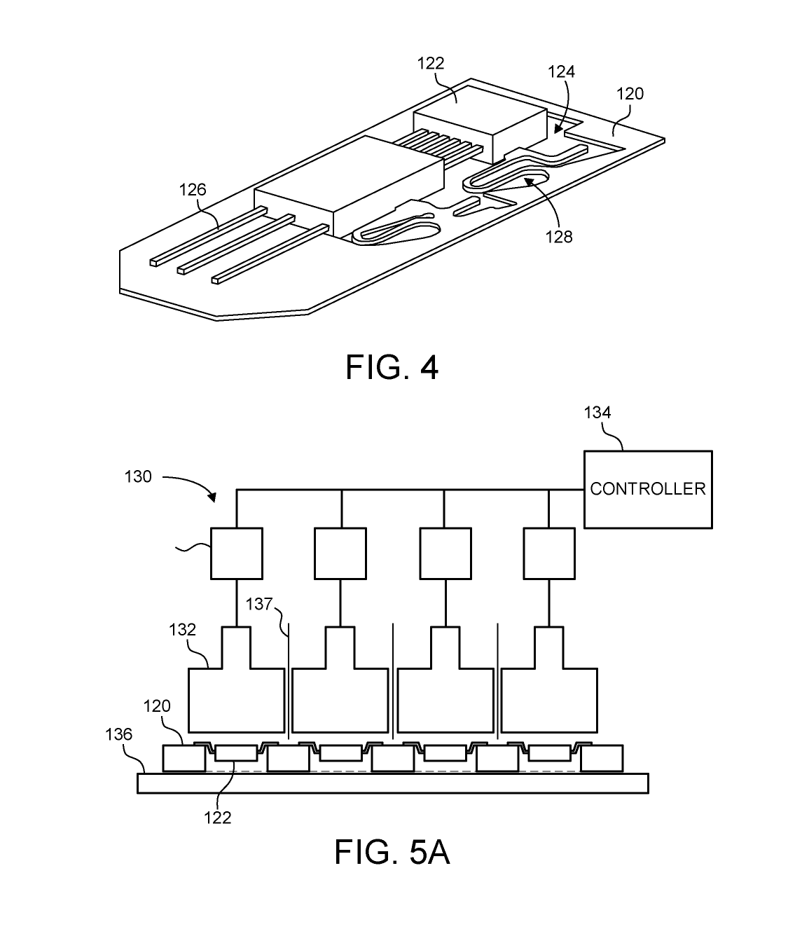

FIG. 4 depicts a perspective view of another embodiment of a singulated sensor device positioned in a mounting aperture of the carrier of FIG. 2.

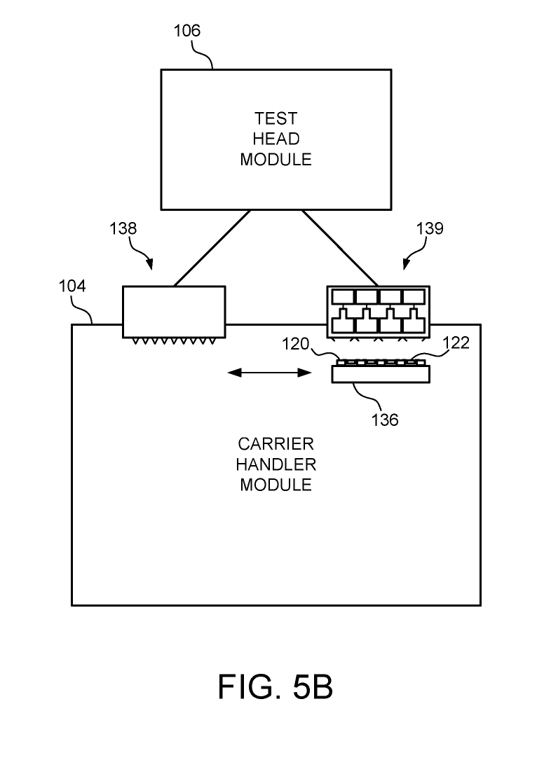

FIG. 5A depicts a schematic block diagram of one embodiment of a testing arrangement with multiple magnetic stimulator heads for testing multiple singulated sensor devices in parallel.

FIG. 5B depicts a schematic block diagram of one embodiment of the parametric and functional testing performed by the test head module of FIG. 1.

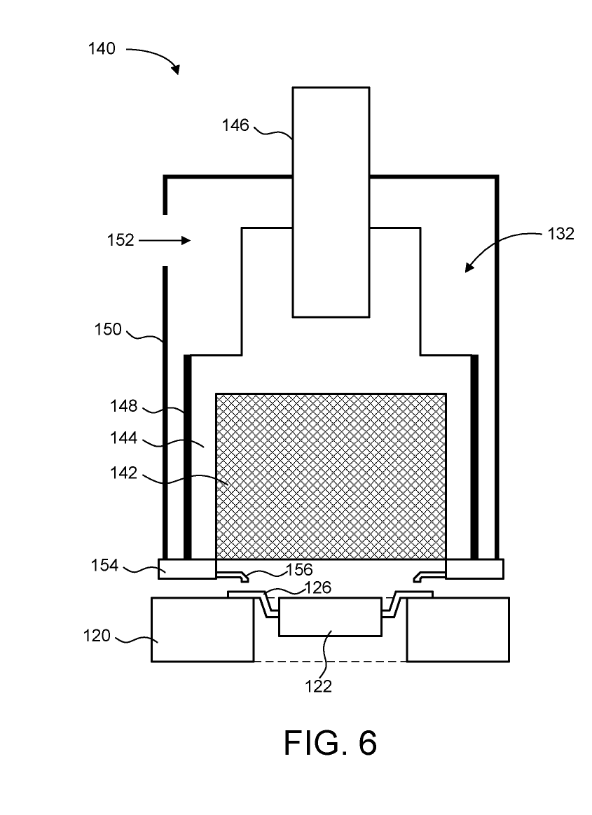

FIG. 6 depicts an arrangement of a more detailed embodiment of a magnetic stimulator head relative to a singulated sensor device.

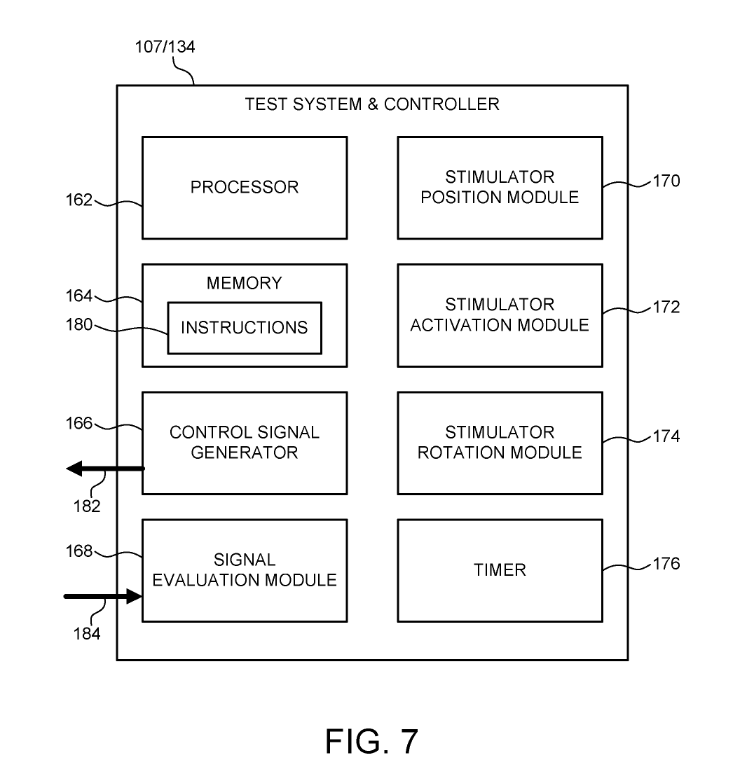

FIG. 7 depicts a schematic block diagram of one embodiment of the controller of FIG. 5A.

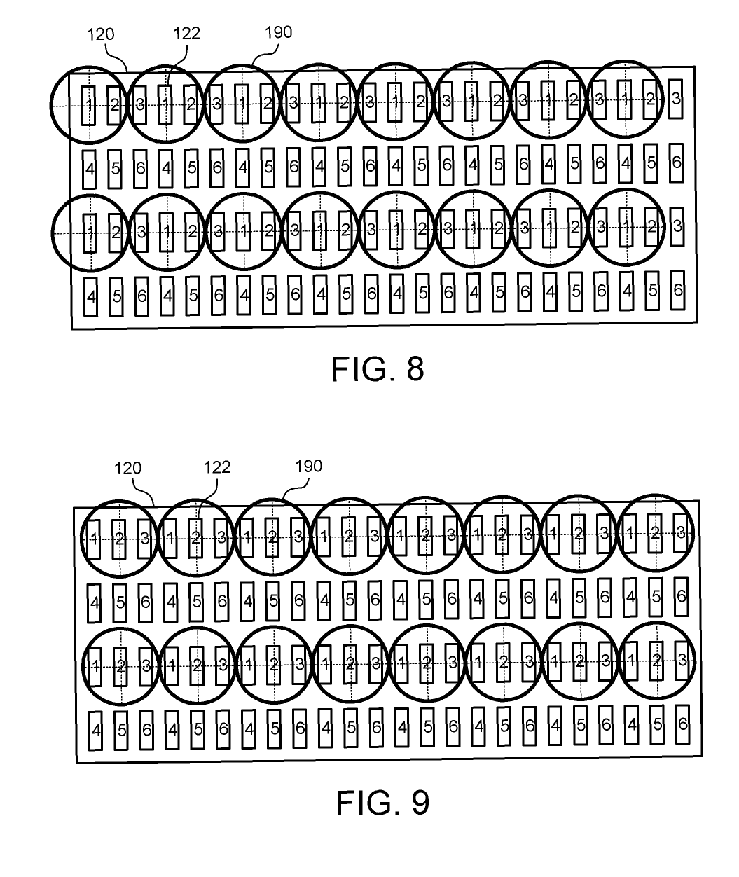

FIG. 8 depicts one embodiment of an array of testing positions, at a first index position, for the magnetic stimulator heads relative to the singulated sensor devices mounted in the carrier.

FIG. 9 depicts another embodiment of an array of testing positions, at a second index position, for the magnetic stimulator heads relative to the singulated sensor devices mounted in the carrier.

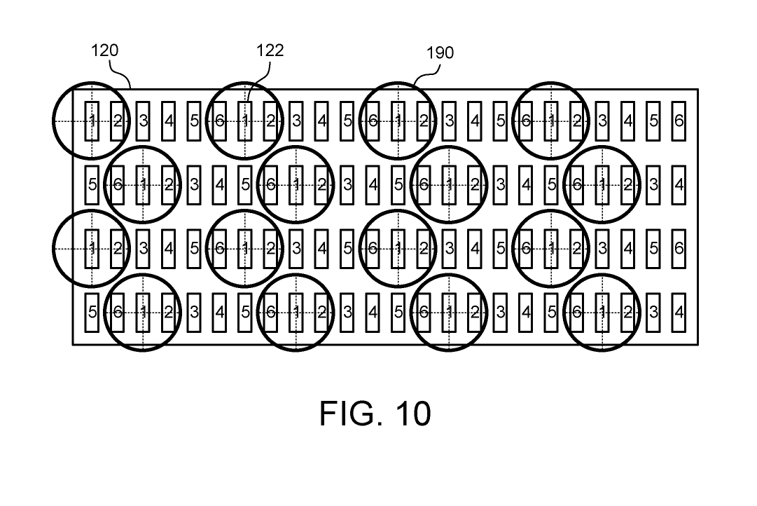

FIG. 10 depicts an alternative embodiment of an array of testing positions for the magnetic stimulator heads relative to the singulated sensor devices mounted in the carrier.

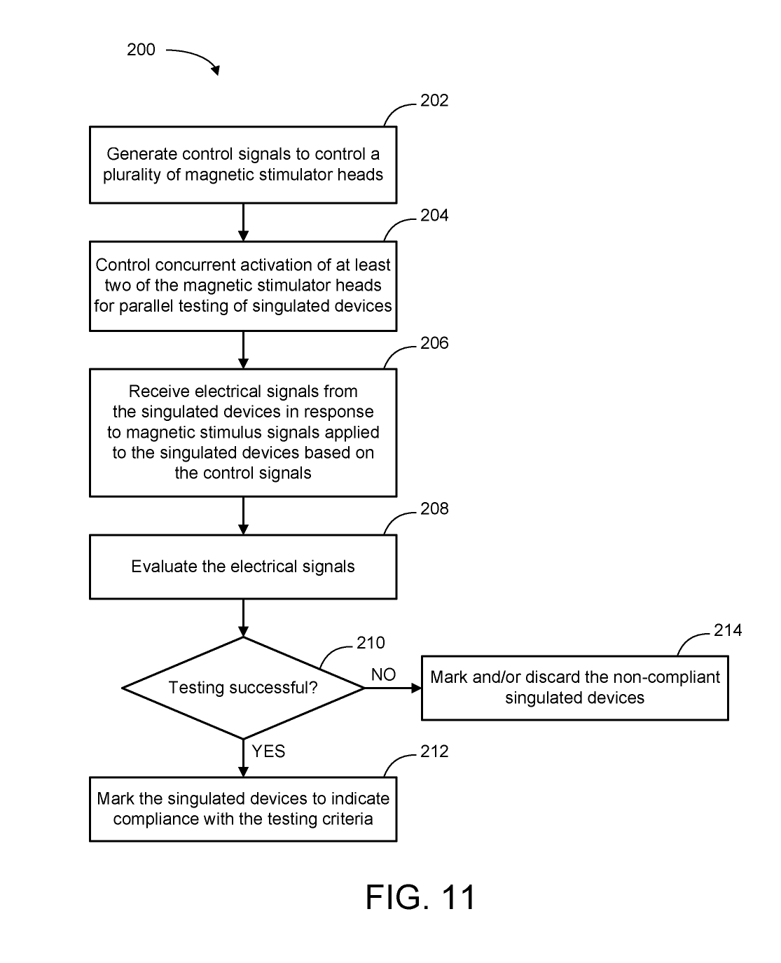

FIG. 11 depicts a flow chart diagram of one embodiment of a method for controlling the test head module of the test cell of FIG. 1.

Throughout the description, similar reference numbers may be used to identify similar elements.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

FIG. 1 depicts a schematic diagram of one embodiment of a test cell 100. The illustrated test cell 100 includes a carrier loading module 102, a carrier handler module 104, a test head module 106, a test system 107, a carrier unloading module 108, and a system controller 110. The system controller 110 also may be referred to as a data processing unit. Although the test cell 100 is shown and described with certain components and functionality, other embodiments of the test cell 100 may include fewer or more components to implement less or more functionality.

In general, the test cell 100 operates to test sensor devices (refer to FIGS. 2-4) to verify that the sensor devices perform correctly under application environmental conditions. For convenience, the test cell 100 is described in conjunction with a magnetic steering application for magneto-resistive (MR) sensors; however, embodiments of the test cell 100 may operate to test other types of sensors or devices. Also, as explained above, the MR sensors are generically referred to as (X)MR sensors, which are inclusive of anisotropic (A)MR, giant (G)MR, and terra (T)MR sensors. In a specific embodiment, the magnetic steering application is in a sensitive direction to realize high throughput multisite approach for a backend final test.

In order to test the sensor devices within the test cell 100, the sensor devices are singulated and loaded onto a carrier (refer to FIG. 2) that holds each of the singulated sensor devices in a known position. Other machines (not shown) may be used to prepare (i.e., singulate) and load the sensor devices into the carriers, prior to presenting the carriers at the test cell 100 shown in FIG. 1. The details of such machines and operations are known and, hence, are not described in detail herein. The loaded carriers are then presented to the test cell 100 for handling and testing, as described below.

In one embodiment, the carrier loading module 102 operates to receive one or more carriers that are loaded with sensor devices. The carrier loading module 102 may hold the carriers in a stack, or other arrangement, in anticipation of loading the carriers into the carrier handler module 104. Embodiments of the carrier loading module 102 may include a conveyor belt, a robotic arm, or another mechanical transfer mechanism to pass each carrier into the carrier handler module 104. In one embodiment, the system controller 110 controls the timing and operations of the carrier loading module 102.

In one embodiment, the carrier handler module 104 moves the carrier, with the corresponding sensor devices, from the carrier loading module 102 to the test head module 106. At the test head module 106, the sensor devices are tested by the test system 107. In one embodiment, the test head module 106 implements contacting and stimulating to perform parametric and functional testing. In general, parametric testing refers to tests that do not require magnetic stimulation. One example of parametric testing includes pure electrical tests such as contact, amplifier, digital scan, and leakage tests. Functional testing refers to tests that use magnetic stimuli.

During the testing, the carrier handler module 104 may move the carrier and sensor devices in different directions (e.g., vertically, horizontally, and/or rotationally) to position the sensor devices relative to individual testing heads (refer to FIG. 5A). In one embodiment, the carrier handler module 104 includes a chuck 136 (refer to FIG. 5A), which holds the carrier relative to moving mechanical components (e.g., a conveyor belt, a robotic arm, etc.). Once the testing of the sensor devices is completed, the carrier handler module 104 transfers the carrier to the carrier unloading module 108. In one embodiment, the system controller 110 controls the timing and operations of the carrier handler module 104, including moving the chuck (and, hence, the carrier) into various positions within the test head module 106, as well as from the carrier loading module 102 and to the carrier unloading module 108.

In one embodiment, the carrier unloading module 108 positions the carriers in a stack, or other arrangement, to hold the carriers until the carriers are removed by an operator. In one embodiment, the system controller 110 controls the timing and operations of the carrier unloading module 108. Depending on the capacity of the carrier loading module 102 and the carrier unloading module 108, the test cell 100 may test sensor devices mounted in several (e.g., 20 or more) carriers, without requiring intervention or control by a human operator.

The system controller 110 also allows a human operator, or another automated operator, to set various parameters related to the handling and testing of the sensor devices within the test cell 100. The system controller 110 also allows a human operator, or another automated operator, to start the testing process using the test cell 100. Additionally, the system controller 110 may generate a notification signal to notify the human operator, or another automated operator, of a status or error of the sensor testing process. Other embodiments of the system controller 110 perform additional processing and/or control functions. Additionally, in some embodiments, the system controller 110 interfaces with a separate controller (refer to FIGS. 5A and 7) that is used within the test system 107 to control some or all of the actual testing operations.

The type of testing conditions implemented by the test head module 106 depend, at least in part, on the type of sensor devices that are to be tested by the test cell 100. In one embodiment, the test head module 106 facilitates the testing of singulated devices in parallel under to application environmental conditions. The chuck 136 in the carrier handler module 104 supported by the test head module 106 produces the application environmental conditions to resemble environmental conditions anticipated during use of the singulated devices within, for example, a safety system. As one example of application environmental conditions, the test cell components 106 and 104 may produce relatively low and high temperatures, so that the sensor devices may be tested at low temperatures (e.g., −40° C., min −55° C.), at room temperatures (e.g., about 23° C.), and at high temperatures (e.g., 120° C., min 170° C.). Other embodiments may produce temperatures within different ranges. Additionally, the test cell components 106 and 104 may change other environmental conditions by manipulating, for example, humidity, temperature, ESD and EMV conditions, pressure, wind chill, and so forth. These factors could be accelerations in the x, y, and z directions and/or rotations along several axes.

In one embodiment, the test head module 106 is configured for testing (X)MR sensor devices. Some embodiments described herein combine features from both the InCarrier standard industrial test handler and dynamic shielding of a magnetic stimulus, as described below. This combination results in a sensor final test solution with the possibility of a multisite approach, which means that several dynamic shielded MR stimuli may be driven in parallel to steer and measure several devices in parallel. As one example, the test head module 106 may drive up to 16 magnetic stimulator heads in parallel to simultaneously (or at relatively the same time) test 16 singulated sensor devices.

A potential advantage of one embodiment of the test head module 106 described herein is high parallelism of testing (X)MR sensor devices. This high parallelism results in high throughput and cost reduction compared to conventional final test solutions. Other embodiments of the test head module 106 may exhibit additional advantages over conventional testing equipment and techniques. Besides the high multisite testing, the carrier can be adapted to other package types using the same types of stimuli.

In some embodiments, magnetic crosstalk can be reduced or minimized if the magnetic stimuli are working at the same time in different frequency domains. A potentially disturbing signal (e.g., cause by the magnetic field from a neighboring site) can be easily removed after a Fourier transformation. This means that only the signal coming from the intended stimulation unit is used for calibration and measuring purposes. Frequencies at which each magnetic stimuli is rotating can be carefully selected in order to avoid any harmonics which might disturb other site signals or mixed components to come into the useful spectrum. Some advantages of embodiments which use this method include higher immunity to site-to-site crosstalk, which would allow a higher density of stimuli and therefore lower test costs per device.

FIG. 2 depicts a schematic diagram of one embodiment of a carrier 120 to hold a plurality of singulated sensor devices 122 for testing in the test cell 100 of FIG. 1. The illustrated carrier 120 specifically holds up to 96 sensor devices 122, arranged in four equal rows of 24 devices per row. Other embodiments of the carrier 120 may hold fewer or more sensor devices 122, depending on the size and dimensions of the carrier 120, as well as the size and dimensions of the singulated sensor devices 122. Additional details of embodiments of the carrier 120 are shown in FIGS. 3 and 4 and described in more detail below.

FIG. 3 depicts a sectional view of one embodiment of a singulated sensor device 122 positioned in a mounting aperture 124 of the carrier 120 of FIG. 2. In the illustrated embodiment, the singulated sensor device 122 is positioned up-side-down in the mounting aperture 124 of the carrier 120 so that electrical leads 126 of the sensor device 122 are exposed at the top side of the carrier 120. This configuration allows the electrical leads 126 of the sensor device 122 to be electrically contacted by corresponding electrical contacts 156 on the corresponding test head (refer to FIG. 6), as described below. Other embodiments of the carrier 120 may hold the sensor devices 122 with the electrical leads 126 accessible in another manner.

FIG. 4 depicts a perspective view of another embodiment of a singulated sensor device 122 positioned in a mounting aperture 124 of the carrier 120 of FIG. 2. The illustrated carrier 120 of FIG. 4 shows more detail of a mechanical spring 128 which applies a force on the sensor device 122 to hold the sensor device 122 in the mounting aperture 124 of the carrier 120. This applied force helps to keep the sensor device 122 from falling out of the mounting aperture 124 as the carrier 120 is moved through the test cell 100.

In one embodiment, the carrier 120 is fabricated from multiple layers of material that are stacked on top of each other. Although not shown in the illustration of FIG. 3, one example of the carrier 120 includes a base plate, a spring plate, and a cover plate including electrical isolation. In general, the spring plate is interposed between the base plate and the cover plate, which are fabricated from thin sheets of relatively strong and stable material (e.g., 0.2 mm steel sheet metal). The mechanical spring 128 is formed in the spring layer between the base plate and the cover plate. In some embodiments, a special machine may be used to compress the mechanical spring 128 for initial loading of the singulated sensor devices 122 into the mounting apertures 124 and subsequently for unloading the singulated sensor devices 122 from the mounting apertures 124. Other embodiments of the carrier 120 may be fabricated using different layers and/or using different types of retention mechanisms for holding the sensor devices 122 in place during testing.

FIG. 5A depicts a schematic block diagram of one embodiment of a testing arrangement 130 with multiple magnetic stimulator heads 132 for testing multiple singulated sensor devices 122 in parallel. Each magnetic stimulator head 132 is electrically coupled to motors 133 which are controlled by a controller 134, which controls the movements and operations of the individual magnetic stimulator heads 132. Specifically, in some embodiments, the controller 134 sends control signals to the motors 133, which rotate the magnetic stimulator heads 132 accordingly. The controller 134 may be incorporated within the test head module 106 and/or the test system 107. In some embodiments, the controller 134 controls operations related to functional testing (i.e., using magnetic stimuli) of the sensor devices 122. For example, the controller 134 controls all of the magnetic stimulator heads 132 in parallel so that the movements and operations of the magnetic stimulator heads 132 are substantially synchronized. In other embodiments, the controller 134 controls the magnetic stimulator heads 132 independently of one another, so that the magnetic stimulator heads 132 may or may not be synchronized with one another.

Additionally, the controller 134 controls operations related to parametric testing (i.e., using electrical signals) of the sensor devices 122. The parametric testing can be performed in the presence or absence of magnetic stimuli. Some examples of parametric tests include a contact test, an amplifier test, a digital scan test, and a leakage test. Other types of parametric tests also may be implemented. A detailed example of one embodiment of the controller 134 is shown in FIG. 7 and described in more detail below.

In one embodiment, the carrier 120 with the singulated sensor devices 122 is fixed on a chuck 136 within the carrier handler module 104. As described above, the chuck 136 holds and moves the carrier 120 as needed within the test cell 100.

In one embodiment, the magnetic stimulator heads 132 provides magnetic stimulus signals to the singulated sensor devices 122. The controller 134 is coupled to the magnetic stimulator heads 132 to control concurrent activation of at least two or more of the magnetic stimulator heads 132 for parallel testing of the singulated sensor devices 122. The controller 134 also controls operations of the magnetic stimulator heads 132 to regulate an amount of electromagnetic interference at the singulated devices 122. The controller 134 also may control operations of the test system 107 to perform parallel parametric testing of multiple sensor devices 122. In some embodiments, compared with parallel functional testing, the parametric testing can be performed at a higher multisite count because the parametric testing equipment has a smaller mechanical contact site pitch. Thus, more sensor devices 122 can be tested in parallel for the parametric testing than for the functional testing.

FIG. 5B depicts a schematic block diagram of one embodiment of the parametric and functional testing performed by the test head module 106 of FIG. 1. In the illustrated embodiment, the singulated devices 122 are placed in the carrier 120 and on the chuck 136 within the carrier handler module 104. The chuck 136 can move between a parametric testing position 138 and a functional testing position 139. At the parametric testing position 138, parametric tests are performed on the sensor devices 122. As explained above, the parametric testing can be performed in parallel for multiple sensor devices 122 at the parametric testing position 138. At the functional testing position 139, functional tests are performed on the sensor devices 122. As explained above, the functional testing can be performed in parallel for multiple sensor devices 122 at the functional testing position 139.

While many embodiments are described herein, at least some of the embodiments overcome the disadvantage of conventional testing systems in which throughput of the test concept is mainly limited by the amount of sites which can be magnetically stimulated in parallel. Since magnetic stimuli are used only for a part of the overall test, methods to improve throughput can be implemented as described herein. In one embodiment, the testing is divided into two cases, one in which magnetic stimuli are present and one in which magnetic stimuli are not present. In the functional tests which do not rely on magnetic stimuli, the test parallelism can be enhanced to the tester capability limits. An example of such an arrangement, the carrier 136 may be calibrated and magnetically stimulated under the magnetic stimuli, then after completing the functional testing using the magnetic stimuli, all other parametric tests which can be performed without magnetic stimuli are done at the other position with an enhanced parallelism. In this way, the overall throughput is enhanced and lower cost of test is enabled.

FIG. 6 depicts an arrangement of a more detailed embodiment of a magnetic stimulator head 132 relative to a singulated sensor device 122. The illustrated magnetic stimulator head 132 includes a magnet 142 mounted within a housing 144. The housing 144 is attached to a shaft 146 which, upon application of a rotational force, rotates the housing 144 and the magnet 142.

The magnetic stimulator head 132 also includes a magnetic shield 148 which is attached to the housing 144, so that the magnetic shield 148 dynamically moves with the housing 144 as the housing 144 rotates. A second magnetic shield 150 is separately mounted away from the magnetic stimulator head 132, so that the position of the second magnetic shield 150 remains static relative to the rotating magnetic stimulator head 132. In one embodiment, the second magnetic shield 150 includes a port 152 so that airflow can enter and leave the chamber in which the magnetic stimulator head 132 is located. In some embodiments, the magnetic stimulator head 132 also includes an electrical shield 137 (schematically shown in FIG. 5A) to shield the sensor signal of the singulated sensor device 122 from electrical interference from the controller 134.

Each magnetic stimulator head 132 includes, or is positioned relative to, an electrical circuit 154 with one or more electrical contacts 156. In one embodiment, as the magnetic stimulator head 132 is moved into position next to the singulated sensor device 122, the electrical contacts 156 physically touch and electrically connect to the electrical leads 126 of the singulated sensor device 122. In this way, as the magnetic stimulator head 132 generates and applies a magnetic stimulus signal to the singulated sensor device 122, the electrical circuit 154 can read out an electrical signal from the corresponding singulated sensor device 122 via the electrical contacts 156. The electrical contacts 156 are connected to the test head and further on to the test system 107. Using this output signal from the singulated sensor device 122, the test system 107 can determine whether or not the singulated sensor device 122 is operating correctly under the environmental conditions imposed by the test head module 106.

With further reference to the magnetic shields 148 and 150, one or both of these magnetic shields 148 and 150 may be useful in shielding the magnetic stimulator head 132 and/or the corresponding singulated sensor device 122 from magnetic interference from other magnetic stimulator heads. Since the controller 134 may operate more than one magnetic stimulator head 132 at the same time, and each magnetic stimulator head 132 generates a magnetic stimulus signal, embodiments of the magnetic shields 148 and 150 can reduce or eliminate the unintended effects of magnetic interference between different testing positions. As explained above, some embodiments include a dynamic magnetic shield 148 which moves with the rotational movement of the magnetic stimulator head 132. Some embodiments include a static magnetic shield 150 which does not move with the rotational movement of the magnetic stimulator head 132. Other embodiments include both dynamic and static magnetic shields 148 and 150. In some embodiments, the magnetic shields 148 and 150 are made of a material such as, for example, Permenorm, although other embodiments may use other materials and/or have other dimensions. In some embodiments, the magnetic stimulator head 132 also includes an electrical shield to shield the sensor signal of the singulated sensor device 122 from electrical interference from the controller 134.

FIG. 7 depicts a schematic block diagram of one embodiment of the test system 107 which may include some or all of the controller 134 of FIG. 5A. The illustrated tester/controller 107/134 includes a processor 162, an electronic memory device 164, a control signal generator 166, a timer 176, and a signal evaluation module 168. The tester/controller 107/134 also includes a stimulator position module 170, a stimulator activation module 172, and a stimulator rotation module 174. Although the tester/controller 107/134 is shown and described with certain components and functionality, other embodiments of the tester/controller 107/134 may include fewer or more components to implement less or more functionality. Also, although the tester/controller 107/134 is described in conjunction with the test cell 100 of FIG. 1, embodiments of the tester/controller 107/134 may be implemented with other types of sensor devices or device testing systems.

Also, it should be noted that the various components of the tester/controller 107/134 may be implemented in hardware and/or software. To the extent that a specific component may be implemented via one or more software instructions, such software instructions are generated by a hardware device (e.g., the processor 162), stored on a hardware memory device (e.g., the electronic memory device 164), and/or executed by a hardware device (e.g., the processor 162). Thus, the operations of the tester/controller 107/134 are dependent on the type of hardware in which the controller is implemented. Further, embodiments of the tester/controller 107/134 described herein are not limited to a particular type of hardware implementation or a particular type of hardware technology, and any contemporary hardware technology or manufacturing process may be used to make the hardware on which the tester/controller 107/134 is implemented.

In one embodiment, the processor 162 executes instructions and performs processing operations to implement that various functions of the tester/controller 107/134. The processor 162 may be any type of processor, including a programmable logic device, an application specific integrated circuit (ASIC), a central processing unit, a multi-processor unit, or another type of processor. Additionally, in some embodiments, one or more of the other components of the tester/controller 107/134 may be integrated with the processor 162 into a single chip or package.

As explained above, the memory 164 stores instructions 180 that may be executed by the processor 162. The instructions 180 may relate to the specific components of the tester/controller 107/134, as well as to the general operation of the processor 162. In particular, the electronic memory device 164 stores instructions 180 for controlling concurrent activation of at least two of the magnetic stimulator heads 132 for parallel testing of the singulated sensor devices 122. Additionally, the memory 164 may store other information, such as operating parameters, user information, and so forth, depending on the setup of the test cell 100.

In one embodiment, the control signal generator 166 provides control signals to the magnetic stimulator heads 132 so that each magnetic stimulator head 132 provides magnetic stimulus signals to singulated sensor devices 122 according to the control signals. The types of control signals generated by the control signal generator 166 may depend, at least in part, on instructions and/or signals generated by the stimulator position, activation, and rotation modules 170, 172, and 174, as described below. One or more output channels 182 are coupled to the control signal generator 166 in order to transmit the control signals to the magnetic stimulator heads 132.

In one embodiment, the signal evaluation module 168 receives electrical signals from the singulated sensor devices 122 via the electrical contacts 156 of the electrical circuit 154. The electrical signals from the singulated sensor devices 122 are dependent on the magnetic stimulus signals applied by the magnetic stimulator heads 132 to the singulated sensor devices 122. The signal evaluation module 168 (or another component of the tester/controller 107/134) evaluates the electrical signals from the singulated sensor devices 122 to determine if the sensor devices 122 are functioning correctly. One or more input channels 184 are coupled to the signal evaluation module 168 in order to receive the electrical signals from the magnetic stimulator heads 132.

In one embodiment, the signal evaluation module 168 compares the electrical signals from a sensor device 122 with signals or data representative of a correct electrical signal. The data representative of the correct electrical signal may be stored, for example, in the memory 164. Alternatively, the signal or data representative of the correct electrical signal may be generated on demand.

In one embodiment, the stimulator position module 170 coordinates relative positioning between the magnetic stimulator heads 132 and the singulated sensor devices 122. In particular, the stimulator position module 170 instructs the control signal generator 166 to send control signals to the magnetic stimulator heads 132 to move the magnetic stimulator heads 132 and physically position the magnetic stimulator heads 132 in a particular pattern relative to the singulated sensor devices 122. Some examples of testing patterns are shown in FIGS. 8-10 and described in more detail below.

In one embodiment, the stimulator activation module 172 controls when each magnetic stimulator head 132 is activated, including when each magnetic stimulator head 132 is turned on and how long each magnetic stimulator head 132 remains on. In some embodiments, the stimulator activation module 172 turns on all of the magnetic stimulator heads 132 at approximately the same time. Alternatively, the stimulator activation module 172 may turn on at least some of the magnetic stimulator heads 132 while other magnetic stimulator heads 132 remain inactive. In a specific example, the stimulator activation module 172 temporally staggers the activation times of at least some of the magnetic stimulator heads 132 by sending corresponding stimulation activation control signals to the control signal generator 166. The timing of the activation times may be controlled by or coordinated with the timer 176.

In some embodiments, the stimulator activation module 172 activates all of the magnetic stimulator heads 132 for approximately the same duration. Alternatively, the stimulator activation module 172 may implement shorter or longer activation times for at least some of the magnetic stimulator heads 132. In a specific example, the stimulator activation module 172 temporally staggers the activation duration times of at least some of the magnetic stimulator heads 132 by sending corresponding stimulation duration control signals to the control signal generator 166. The timing of the activation duration times may be controlled by or coordinated with the timer 176.

In one embodiment, the stimulator rotation module 174 generates a rotation plan to rotate the magnets 142 in at least some of the magnetic stimulator heads 132 at different rotational speeds. In other words, within an array of magnetic stimulator heads 132, the stimulator rotation module 174 rotates some of the magnets 142 more slowly or more quickly than the other magnets 142. As a specific example, the magnets 142 may rotate at 1000, 2000, or 6000 RPM. Additionally, in some embodiments, the control signal generator 166 is able to rotate the magnets 142 to specific static positions. This allows the control signal generator 166 to individually set or calibrate the magnetic stimulus signal of each of the magnetic stimulator heads 132. The stimulator rotation module 174 sends corresponding stimulator rotation control signals to the control signal generator 166 for communication to or control of the magnetic stimulator heads 132.

In some embodiments, when the magnetic stimulator heads 132 are rotated at different rotational speeds, the signal evaluation module 168 applies a Fourier transform operation to the electrical signals produced by the singulated sensor devices 122. The Fourier transform operation enables identification of the electrical signal from a specific sensor device 122, distinguished from the electrical signals of other sensor devices 122. The Fourier transform operation is dependent on the corresponding magnetic stimulus signal used to stimulate the electrical signal from the sensor device 122.

FIG. 8 depicts one embodiment of an array of testing positions 190, at a first index position, for the magnetic stimulator heads 132 relative to the singulated sensor devices 122 mounted in the carrier 120. For reference, each of the index positions is designated 1-6 at the corresponding locations of the sensor devices 122. Thus, in the depicted embodiment, 16 magnetic stimulator heads 132 are positioned at the testing position 190 indicated by the circles, which are centered on the locations of the sensor devices 122 designated by the number “1.”

FIG. 9 depicts another embodiment of an array of testing positions 190, at a second index position, for the magnetic stimulator heads 132 relative to the singulated sensor devices 122 mounted in the carrier 120. Similar to the illustration of FIG. 8, FIG. 9 shows the locations of the magnetic stimulator heads 132 at the testing positions 190 corresponding to the locations of the sensor devices 122 designated by the number “2.” Over the course of six total indexing movements, the 16 magnetic stimulator heads 132 can align with and test all of the singulated sensor devices 122 mounted on the carrier 120.

The number of index positions for a specific embodiment depends on the number of magnetic stimulator heads 132, as well as the number of singulated sensor devices 122 on the carrier 120. The number of index positions also may depend on the configuration and/or relative movements of the magnetic stimulator heads 132.

The number of magnetic stimulator heads 132 that may be implemented in a particular embodiment depends on the size of the magnets 142 used in the magnetic stimulator heads 132. As one example, 16 magnets 142 may be used if each magnet 142 is approximately 10 mm in diameter. For 96 sensor locations, the magnetic stimulator heads 132 may be moved to six different index locations to test all of the sensor devices 122. As another example, eight magnets 142 may be used if each magnet 142 is approximately 20-30 mm in diameter. For 96 sensor locations, the magnetic stimulator heads 132 may be moved to twelve different index locations to test all of the sensor devices 122. Other embodiments may use other sizes of magnets 142, quantities of sensor devices 122, and/or numbers of index positions.

FIG. 10 depicts an alternative embodiment of an array of testing positions 190 for the magnetic stimulator heads 132 relative to the singulated sensor devices 122 mounted in the carrier 120. In particular, FIG. 10 shows a staggered pattern of testing positions 190 relative to the array of singulated sensor devices 122. In this case, there may be some additional indexing, compared with a non-staggered pattern, in order to index some of the sensor devices 122 at the beginning and end of the array. In any case, the control signal generator 166 provides the control signals, including stimulator position control signals, to the magnetic stimulator heads 132. Other embodiments may use other patterns of testing positions 190.

FIG. 11 depicts a flow chart diagram of one embodiment of a method 200 for controlling the test head module 106 of the test cell 100 of FIG. 1. Although the method 200 is described in conjunction with the test head module 106 of the test cell 100 of FIG. 1, embodiments of the method 200 may be implemented in conjunction with other test head modules and/or test cells.

In the depicted embodiment, at block 202 the control signal generator 166 generates control signals to control the magnetic stimulator heads 132. As explained above, each magnetic stimulator head 132 provides a magnetic stimulus signal to the corresponding singulated sensor device 122 for testing in response to the control signals. At block 204, the control signal generator 166 controls concurrent activation of at least two of the magnetic stimulator heads 132 for parallel testing of the singulated sensor devices 122. Concurrent activation generally refers to some point in time at which two or more magnetic stimulator heads 132 are active. While concurrent activation may include starting the magnetic stimulator heads 132 at the same time, concurrent activation also includes other times during which the magnetic stimulator heads 132 are active even if they are started or terminated at different times.

At block 206, the signal evaluation module 168 receives electrical signals from the singulated sensor devices 122. As explained above, the electrical signals from the singulated sensor devices 122 are dependent on the magnetic stimulus signals applied by the magnetic stimulator heads 132 to the singulated sensor devices 122. At block 208, the signal evaluation module 168 evaluates the electrical signals and, at block 210, determines if the testing is successful. If the testing is successful, and a sensor device 122 operates correctly under the applied environmental conditions, then at block 212 the controller 134 marks the singulated sensor device 122 to indicate compliance with the testing criteria. Otherwise, if the testing is not successful, and a sensor device 122 does not operate correctly under the applied environmental conditions, then at block 214 the controller marks the singulated sensor device 122 to indicate non-compliance with the testing criteria. In one embodiment, the controller 134 marks the individual sensor devices 122 by storing corresponding flags and/or testing data in the memory device 164. Using this information, an operator or another machine may physically mark the compliant and non-compliant sensor devices 122, accordingly. Additionally, the non-compliant sensor devices 122 may be discarded. The depicted method 200 then ends.

In some embodiments, the method 200 also includes providing stimulator position control signals to the magnetic stimulator heads 132 to coordinate relative positioning between the magnetic stimulator heads 132 and the singulated sensor devices 122 such that the magnetic stimulator heads 132 are physically positioned in a staggered or non-staggered pattern relative to an array of the singulated sensor devices 122. In some embodiments, the method 200 also includes providing stimulation activation control signals to the magnetic stimulator heads 132 to temporally stagger activation times of at least some of the magnetic stimulator heads 132. In some embodiments, the method 200 also includes providing stimulator rotation control signals to the magnetic stimulator heads 132 to implement a rotation plan to rotate the magnets 142 in at least some of the magnetic stimulator heads 132 at different rotational speeds. Other embodiments of the method 200 may include additional operations to implement the functionality described herein.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

1. A resistor-equipped transistor comprising:
a package providing an external collector connection node, an external emitter connection node and an external base connection node and containing:
a substrate supporting
a transistor having an internal collector, an internal emitter and an internal base;
a first resistor electrically connected between the internal base and the external base connection node;
a second resistor electrically connected between the internal base and the internal emitter;
a first diode having a cathode and an anode;
a second diode having a cathode and an anode, the first and second diodes electrically coupled in series between the external base connection node and the external collector connection node with the first diode in a first cathode-anode orientation that is opposite of a second cathode-anode orientation corresponding to the second diode.

2. The transistor of claim 1, wherein the transistor has a collector-emitter breakdown voltage and a collector-base breakdown voltage and wherein the first diode and second diode are configured with breakdown voltages higher than the collector-emitter breakdown voltage and the collector-base breakdown voltage.

3. The transistor of claim 1, wherein the first and second diode are part of a floating-base transistor.

4. The transistor of claim 1, wherein the first resistor and the second resistor are polysilicon resistors and wherein the substrate is a doped silicon substrate.

5. The transistor of claim 1, wherein the package is a surface mount device (SMD) package.

6. The transistor of claim 1, wherein the transistor is a vertical NPN transistor and wherein the transistor further includes a p+ well located between the vertical NPN transistor and the first and second diodes for inhibiting leakage current therebetween.

7. The transistor of claim 1, wherein the transistor is a vertical PNP transistor and wherein the transistor further includes an n+ well located between the vertical PNP transistor and the first and second diodes for inhibiting leakage current therebetween.

8. The transistor of claim 1, wherein the first diode and the second diode are implanted layers within an epitaxially-grown layer on the substrate.

9. A method of manufacturing a device that includes a resistor-equipped transistor, the method comprising:
on a substrate of a first conductivity type, growing an epitaxial layer of the first conductivity type to form a collector of the transistor, one of the substrate and the epitaxial layer forming either a cathode or an anode of a first diode;
implanting and diffusing at least a first region within the epitaxial layer to form either a common anode or a common cathode of the first diode and of a second diode and to form an internal base of the transistor, the at least first region being of a second conductivity type that is opposite of the first conductivity type;
implanting and diffusing a second region of the first conductivity type within either the implanted first region or the epitaxial layer to form either a cathode or an anode of the second diode;
implanting and diffusing a third region of the first conductivity type to form an emitter of the transistor;
forming an oxide layer on the grown epitaxial layer and the implanted regions;
depositing material with a high-sheet resistance on the oxide layer to form first and second resistors, the first resistor electrically connected between the second region and the internal base of the transistor and the second resistor electrically connected between the internal base of the transistor and the emitter of the transistor; and
electrically connecting the second region, the emitter of the transistor, and the collector of the transistor to respective bond pads.

10. The method of claim 9, further comprising packaging the resistor-equipped transistor in a surface-mount device (SMD) package.

11. The method of claim 9, wherein the step of implanting and diffusing the at least a first region includes implanting two separate regions of the second conductivity type within the epitaxial layer, the first region forming either the common anode or the common cathode of the first and second diodes and a further region forming the internal base of the transistor, and wherein the substrate forms either the cathode or the anode of the first diode and the emitter of the transistor is formed by implanting and diffusing the third region in the further region.

12. The method of claim 9, wherein the step of implanting and diffusing the at least a first region includes implanting only the first region in the epitaxial layer, the first region forming either the common anode or the common cathode of the first and second diodes and forming the internal base of the transistor, and wherein the epitaxial layer forms either the cathode or the anode of the first diode and the emitter of the transistor is formed by implanting and diffusing the third region in the first region.

13. The method of claim 12, further comprising implanting and diffusing a fourth region of the second conductivity type within the implanted first region to form an isolation well that is located between the implanted second region and the implanted third region.

14. The method of claim 9, wherein the steps of growing the epitaxial layer and implanting and diffusing the at least first region include
growing a first part of the epitaxial layer on the substrate,
implanting and diffusing the first region within the first part of the epitaxial layer to form either the common anode or the common cathode of the first and second diodes,
after implanting and diffusing the first region, growing a second part of the epitaxial layer on the first part, and
after growing the second part of the epitaxial layer, implanting and diffusing a further region of the second conductivity type within the epitaxial layer to form the internal base of the transistor, and
wherein the emitter of the transistor is formed by implanting and diffusing the third region in the further region.

15. The method of claim 9, wherein the resistor-equipped transistor is an NPN resistor-equipped transistor, the first conductivity type is n type, the second conductivity type is p type, one of the substrate and the epitaxial layer form the cathode of the first diode, the first region forms the common anode of the first and second diodes, and the second region forms the cathode of the second diode.

16. The method of claim 9, wherein the resistor-equipped transistor is an PNP resistor-equipped transistor, the first conductivity type is p type, the second conductivity type is n type, one of the substrate and the epitaxial layer form the anode of the first diode, the first region forms the common cathode of the first and second diodes, and the second region forms the anode of the second diode.

17. A method of manufacturing a device that includes a resistor-equipped transistor, the method comprising:
on a substrate of a first conductivity type, growing a first part of an epitaxial layer of the first conductivity type to form a collector of the transistor, the substrate forming either a cathode or an anode of a first diode;
implanting and diffusing a first region within the first part of the epitaxial layer to form either a common anode or a common cathode of the first diode and of a second diode, the first region being of a second conductivity type that is opposite of the first conductivity type;
after implanting and diffusing the first region, growing a second part of the epitaxial layer on the first part, and
after growing the second part of the epitaxial layer, implanting and diffusing a second region of the second conductivity type within the epitaxial layer to form an internal base of the transistor;
implanting and diffusing a third region of the second conductivity type within the epitaxial layer to form isolation of the second diode;
implanting and diffusing a fourth region of the first conductivity type within the epitaxial layer to form either a cathode or an anode of the second diode;
implanting and diffusing a fifth region of the first conductivity type within the implanted second region to form an emitter of the transistor;
forming an oxide layer on the grown epitaxial layer and the implanted regions;
depositing material with a high-sheet resistance on the oxide layer to form first and second resistors, the first resistor electrically connected between the fourth region and the internal base of the transistor and the second resistor electrically connected between the internal base of the transistor and the emitter of the transistor; and
electrically connecting the fourth region, the emitter of the transistor, and the collector of the transistor to respective bond pads.

18. The method of claim 17, wherein the step of implanting and diffusing a second region and the step of implanting and diffusing a third region are performed in a single processing step.

19. The method of claim 17, wherein the step of implanting and diffusing a fourth region and the step of implanting and diffusing a fifth region are performed in a single processing step.

20. The method of claim 17, wherein further comprising packaging the resistor-equipped transistor in a surface-mount device (SMD) package.
